(19) United States
(12) Patent Application Publication
(10) Pub. No.: US 2021/0213801 A1
(43) Pub. Date: Jul. 15, 2021

(54) AIR CONDITIONING CONTROL SYSTEM AND CONTROL DEVICE FOR VEHICLE

(71) Applicant: DENSO CORPORATION, Kariya-city (JP)

(72) Inventor: Marie NAGAHAMA, Kariya-city (JP)

(21) Appl. No.: 17/215,989

(22) Filed: Mar. 29, 2021

Related U.S. Application Data
(63) Continuation of application No. PCT/JP2019/037979, filed on Sep. 26, 2019.

(30) Foreign Application Priority Data
Oct. 4, 2018 (JP) 2018-189328

(51) Int. Cl. B60H 1/00; B60H 1/24

(52) U.S. Cl. CPC B60H 1/00792; B60H 1/00828; B60H 1/242

(57) ABSTRACT

An air conditioning control system includes: an air conditioner configured to send a conditioned air that is lower in temperature than air inside a cabin; a detector configured to detect a state of a seat back of a seat; and a controller that lowers temperature of the conditioned air blown out from an air outlet when the detector detects that the state of the seat back being switched from an upright state to a reclined state. The controller increases a volume of the conditioned air blown out from the air outlet when the temperature of the conditioned air blown out from the air outlet is lowered.

### CROSS REFERENCE TO RELATED APPLICATIONS

The present application is a continuation application of International Patent Application No. PCT/JP2019/037979 filed on Sep. 26, 2019, which designated the U.S. and claims the benefit of priority from Japanese Patent Application No. 2018-189328 filed on Oct. 4, 2018. The entire disclosures of all of the above applications are incorporated herein by reference.

### TECHNICAL FIELD

The present disclosure relates to an air conditioning control system and a control device for a vehicle.

### BACKGROUND

An orientation of an air outlet port of a blower is changeable according to an inclination angle of a seat back detected by a position sensor, so that an occupant can receive conditioned air regardless of the inclination angle of the seat back.

### SUMMARY

According to an aspect of the present disclosure, an air conditioning control system for a vehicle includes: a seat disposed in a cabin; an air conditioner configured to send a conditioned air that is lower in temperature than air inside the cabin; an air outlet provided in an instrument panel to blow the conditioned air into the cabin; a detector configured to detect a state of a seat back of the seat; and a controller that controls the conditioned air based on a detection result of the detector. The controller controls the conditioned air blown out from the air outlet based on the state of the seat back being switched from an upright state to a reclined state.

### BRIEF DESCRIPTION OF DRAWINGS

FIG. 1 is a schematic view illustrating a cabin in which an air conditioning control system according to a first embodiment is arranged and a seat back is in an upright state.

FIG. 2 is a schematic view of the cabin in which the seat back is in a reclined state.

FIG. 3 is a cross-sectional view around an air outlet in the first embodiment.

FIG. 4 is a cross-sectional view around an air outlet in Comparative Example 1.

FIG. 5 is a schematic view illustrating a flow direction of conditioned air blown from the air outlet of the first embodiment.

FIG. 6 is a schematic view illustrating another flow direction of conditioned air blown from the air outlet of the first embodiment.

FIG. 7A is a flowchart of a control process executed by a controller of the first embodiment.

FIG. 7B is a time chart illustrating changes in the flow direction, temperature, and volume of the conditioned air blown out from the air outlet by the control process executed by the controller of the first embodiment.

FIG. 8 is a schematic view of a cabin in which a seat back is in a reclined state, in Comparative Example 2.

FIG. 9 is a cross-sectional view around an air outlet in a second embodiment.

FIG. 10 is a cross-sectional view around the air outlet of the second embodiment.

FIG. 11 is a flowchart of a control process executed by a controller of a third embodiment.

FIG. 12 is a schematic view of a cabin, when a seat back is in a reclined state, in which an air conditioning control system according to the third embodiment is arranged.

### DESCRIPTION OF EMBODIMENT

To begin with, examples of relevant techniques will be described.

An orientation of an air outlet port of a blower provided in a rear-view mirror of an automobile is changeable according to an angle of a seat back detected by a position sensor, so that an occupant can receive air at a predetermined part regardless of the angle of the seat back.

Generally, an air conditioner blows wind from a face outlet provided in an instrument panel toward the upper body of an occupant. If the above-described blower is applied to such an air conditioner for an automobile (hereinafter referred to as “combination device”), the flow direction of air blown from the face outlet is changeable in response to the angle of the seat back.

In case where the conditioned air is blown to the chest of the occupant regardless of the angle of the seat back, the above-described device can easily provide the conditioned air to the chest of the occupant even if the seat back is reclined (hereinafter referred to as “reclined state”) since the position of the air outlet is high near the ceiling. However, the above-described device needs a duct from the air conditioner arranged inside the instrument panel to the ceiling, or another blower separately from the blower of the air conditioner.

In the case of the combination device, the instrument panel is provided with the face outlet, so that the above issues do not occur. However, in the case of the combination device, the air outlet is located at a lower position than the above-described device. Further, in the combination device, when the seat back is in the reclined state, the flow direction of the air blown from the face outlet is set to a linear direction toward the chest of the occupant. Therefore, the air blown from the face outlet reaches the chest of the occupant and then flows from the lower side to the upper side along the body of the occupant.

The occupant may feel uncomfortable when the air that reaches the chest of the occupant flows upward along the body of the occupant. For example, if the occupant is not accustomed to the air flowing upward along the body of the occupant, the occupant feels uncomfortable. Also, if the occupant wants to avoid the air from reaching the face, the occupant feels uncomfortable with the air reaching the face of the occupant. In addition, the temperature of the air changes depending on the temperature of the body of the occupant while the air flows along the body of the occupant. When the temperature of the air reaching the face of the occupant is different from the temperature of the air blown out from the air outlet, the occupant may feel uncomfortable.

In this way, in the combination device, when the seat back is in the reclined state, the air blown from the face outlet reaches the chest of the occupant and then flows upward along the body of the occupant. The present inventor has found out this new issue that the occupant feels uncomfortable. It should be noted that this new issue also occurs when the air is blown out from an air outlet provided in the instrument panel other than the face outlet. In addition, this new issue also occurs when the air is blown from the air outlet toward a predetermined part other than the chest of the occupant.

The present disclosure provides an air conditioning control system and a control device for a vehicle, to restrict the air blown from the air outlet from flowing along the body of the occupant after reaching a predetermined part of the occupant, when the seat back is in the reclined state.

According to one aspect of the present disclosure, an air conditioning control system for a vehicle includes: a seat disposed in a cabin; an air conditioner configured to send a conditioned air that is lower in temperature than air inside the cabin; an air outlet provided in an instrument panel to blow the conditioned air into the cabin; a wind direction variable mechanism configured to change a flow direction of the conditioned air blown out from the air outlet in a vertical direction; a drive unit that drives the wind direction variable mechanism; a detector configured to detect a state of a seat back of the seat; and a controller that controls the drive unit based on a detection result of the detector. The controller controls the drive unit such that the flow direction of the conditioned air blown out from the air outlet changes to upward in the cabin based on the state of the seat back being switched from an upright state to a reclined state.

Accordingly, when the seat back is switched from the upright state to the reclined state, the flow direction of the conditioned air blown from the air outlet changes to the upward direction in the cabin. At this time, since the temperature of the conditioned air blown out from the air outlet is lower than the temperature of air inside the cabin, the conditioned air has a higher density than the air inside the cabin. Therefore, the conditioned air blown upward in the cabin falls toward the occupant due to gravity. The flow direction of the conditioned air toward the occupant while falling is closer to the vertical direction, compared with the original flow direction of the conditioned air blown out from the air outlet.

In this way, the conditioned air blown from the air outlet toward the occupant is blown from the air outlet upward in the cabin, so as to be wind flowing downward to the occupant from the upper side. As a result, when the seat back is in the reclined state, it is possible to restrict the air blown from the air outlet from flowing along the body of the occupant after reaching a predetermined portion of the occupant.

According to another aspect, an air conditioning control system for a vehicle includes: a seat disposed in a cabin; an air conditioner configured to send a conditioned air that is lower in temperature than air inside the cabin; an air outlet provided in an instrument panel to blow the conditioned air into the cabin; a detector configured to detect a state of a seat back of the seat; and a controller that controls a drive unit based on a detection result of the detector. The controller lowers the temperature of the conditioned air blown out from the air outlet based on the state of the seat back being switched from the upright state to the reclined state.

Accordingly, since the temperature of the air generated by the air conditioner is lower than the temperature of the air inside the cabin, the conditioned air has a higher density than the air inside the cabin. Further, when the seat back is switched from the upright state to the reclined state, the temperature of the conditioned air blown from the air outlet is lowered. As a result, the density of the conditioned air becomes higher. Therefore, the conditioned air blown out from the air outlet falls toward the occupant due to gravity. The flow direction of the conditioned air toward the occupant while falling is closer to the vertical direction, compared with a case where the temperature of the conditioned air is not lowered. As a result, when the seat back is in the reclined state, it is possible to restrict the air blown from the air outlet from flowing along the body of the occupant after reaching a predetermined portion of the occupant.

According to another point of view, a control device is used for air-conditioning of a vehicle. The vehicle is equipped with a seat disposed in the cabin, an air conditioner that conditions air that is lower in temperature than air in the cabin, an air outlet defined in an instrument panel to blow the conditioned air into the cabin, a wind direction variable mechanism that can change the flow direction of the conditioned air blown out in the vertical direction, a drive unit that drives the wind direction variable mechanism, and a detector that detects the state of the seat back of the seat.

The control device controls the drive unit so that the flow direction of the conditioned air blown from the air outlet changes to the upward direction in the cabin based on the state of the seat back being switched from the upright state to the reclined state. Accordingly, the same effect can be obtained as that of the above-mentioned air conditioning control system.

From another point of view, the control device is used for air-conditioning of a vehicle. The vehicle has a seat arranged in the cabin, an air conditioner that conditions air to have a temperature lower than that of air inside the cabin, an air outlet provided in the instrument panel to blow the conditioned air into the cabin, and a detector that detects the state of the seat back of the seat.

The control device lowers the temperature of the conditioned air blown out from the air outlet based on the state of the seat back being switched from the upright state to the reclined state. Accordingly, the same effect can be obtained as the above-mentioned air conditioning control system.

A reference numeral attached to each component or the like indicates an example of correspondence between the component or the like and specific component or the like described in embodiments below.

Hereinafter, embodiments of the present disclosure will be described with reference to the drawings. In the respective embodiments described herein, identical or equivalent parts are given identical reference numbers.

### First Embodiment

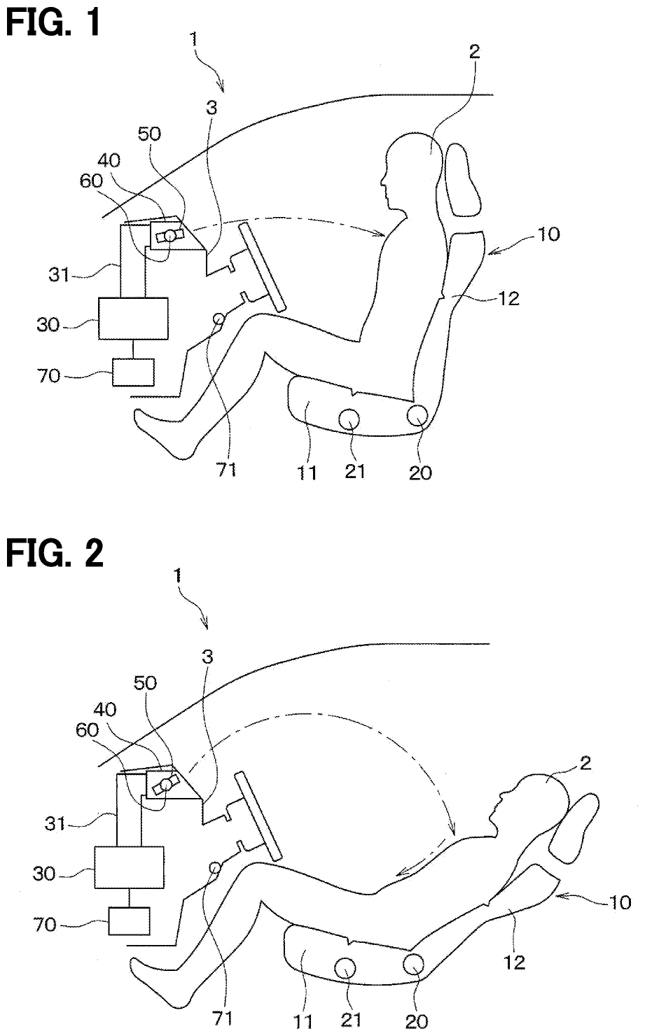

An air-conditioning control system of the present embodiment shown in FIGS. 1 and 2 is used in a vehicle 1 for an occupant, and controls the air-conditioning in the cabin. Specifically, the air-conditioning control system controls the flow direction of the conditioned air blown from the air outlet. The vehicle 1 in which the air-conditioning control system is used may be a car in which an occupant 2 performs a driving operation. The vehicle 1 may be an autonomous driving vehicle in which an automatic driving system performs all driving operations such as acceleration, steering, braking, and monitoring of the surroundings. In the case of an autonomous driving vehicle, it is possible for the occupant to settle on the vehicle with the seat back reclined backward (hereinafter may be referred to as “backward tilted state”) while the vehicle is travelling.

As shown in FIGS. 1 and 2, the air-conditioning control system includes a seat 10, a tilt sensor 20, a front-rear position sensor 21, an air conditioner 30, an air outlet 40, a guide fin 50, a fin drive unit 60, and a controller 70.

The seat 10 is arranged in the cabin. The occupant is seated on the seat 10. The seat 10 has a seat cushion 11 that supports the buttocks and the like of the occupant 2, and a seat back 12 that supports the back of the occupant 2. The seat back 12 is provided so that the angle with respect to the seat cushion 11 can be changed. Further, the seat 10 is provided so as to be movable in the front-rear direction in the vehicle with respect to the floor surface of the cabin.

The tilt sensor 20 is provided on the seat 10. The tilt sensor 20 is a seat back state detector that detects the state of the seat back 12. The tilt sensor 20 detects the angle of the seat back 12 with respect to the seat cushion 11. The tilt sensor 20 transmits the detected information to the controller 70. The controller 70 determines whether the seat back 12 is in the upright state or the reclined state based on the information transmitted from the tilt sensor 20. The backward tilted state is a state in which the seat back 12 is tilted to the rear of the vehicle rather than the upright state.

The front-rear position sensor 21 is provided on the seat 10. The front-rear position sensor 21 detects the position of the seat cushion 11 in the front-rear direction of the vehicle. The front-rear position sensor 21 transmits the detected information to the controller 70.

The air conditioner 30 is arranged inside an instrument panel 3. The instrument panel 3 means an entire panel arranged in front of a front seat in the cabin, and includes not only the portion where the instruments are arranged but also the portion where the audio and the air conditioner are stored. The air conditioner 30 sends air whose temperature and humidity are adjusted. Specifically, the air conditioner 30 sends conditioned air having a temperature lower than that of air inside the cabin. The air conditioner 30 has an air conditioner case. A blower, a cooler, a heater, an air mix door, etc. are arranged inside the air conditioning case. The blower forms an air flow towards the cabin. The cooler cools the air toward the cabin. The heater heats the air flowing out of the cooler. The air mix door adjusts the mixing ratio of the air cooled in the cooler and the air heated in the heater. As a result, the temperature and humidity of the conditioned air toward the cabin are adjusted.

The air outlet 40 is provided in the instrument panel 3. The air outlet 40 is connected to the air conditioner 30 via a duct 31. The air outlet 40 blows out the air conditioned by the air conditioner 30 into the cabin. The air outlet 40 of the present embodiment is a face outlet. The air outlet 40 blows the conditioned air mainly toward the upper body of the occupant 2 and its surroundings. In addition to the face outlet, the vehicle 1 is provided with a defroster outlet, a foot outlet, and the like.

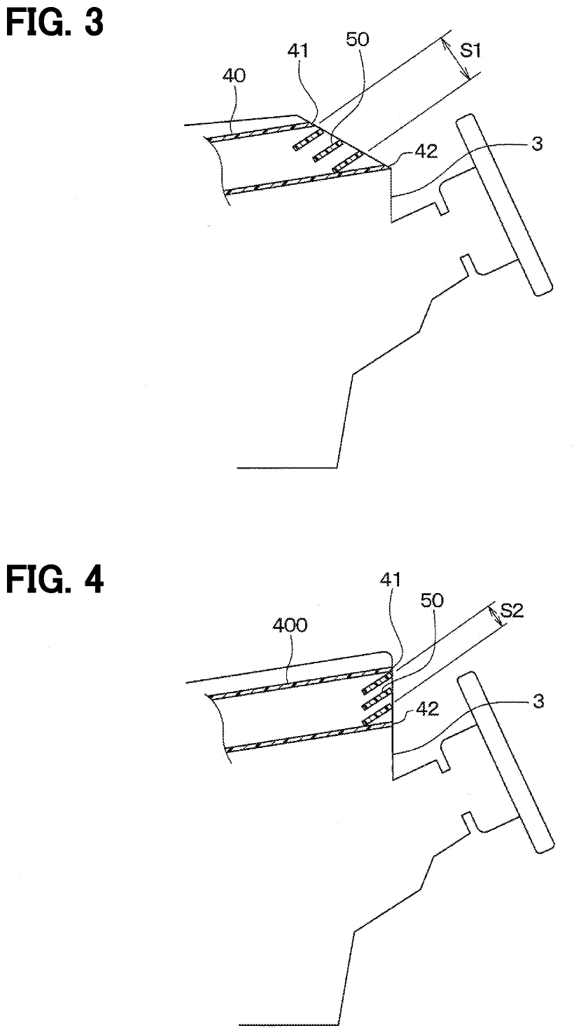

As shown in FIG. 3, in the present embodiment, the upper end 41 of the air outlet 40 is located on the front side than the lower end 42 of the air outlet 40. FIG. 4 illustrates an outlet 400 of Comparative Example 1 for comparison with the air outlet 40 of the present embodiment. In the outlet 400 of Comparative Example 1, the upper end 41 and the lower end 42 are at substantially the same positions in the front-rear direction of the vehicle.

According to the present embodiment, the substantial opening area 51 of the air outlet 40 when the conditioned air is blown upward in the cabin is larger than the substantial opening area S2 of the outlet 400 of Comparative Example 1. As a result, it is possible to reduce the pressure loss of the conditioned air blown upward from the air outlet 40 in the cabin.

The guide fin 50 is provided in the internal space of the air outlet 40. The guide fin 50 is a wind direction variable mechanism capable of changing the flow direction of the conditioned air blown from the air outlet 40 in the vertical direction. The fin drive unit 60 drives the guide fin 50. The fin drive unit 60 is a drive unit that drives the wind direction variable mechanism. The operation of the fin drive unit 60 is controlled by the controller 70. The fin drive unit 60 can adjust and hold the orientation of the guide fin 50 at an arbitrary position.

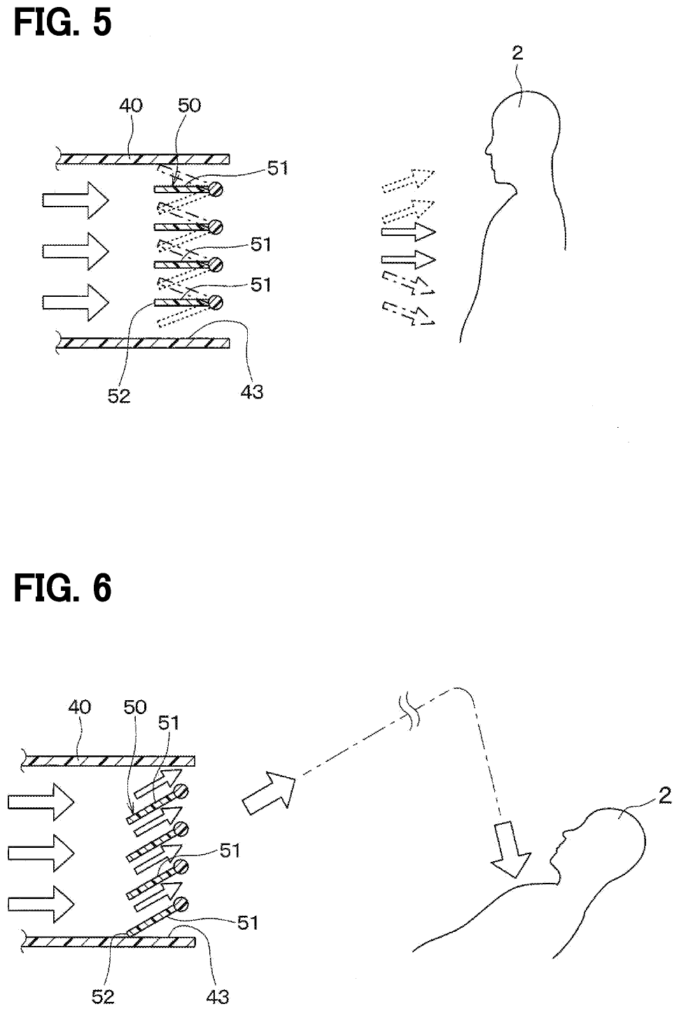

As shown in FIG. 5, the guide fin 50 is composed of plural plate-shaped members 51 arranged in the vertical direction with a space between them. The plate-shaped members 51 are configured to have the same angles with respect to the horizontal direction.

When the guide fin 50 is in the solid line position shown by the solid line in FIG. 5, the conditioned air is blown out from the air outlet 40 toward the chest of the occupant 2 when the seat back 12 is in the upright state. When the guide fin 50 is in the broken line position shown by the broken line in FIG. 5, the conditioned air is blown from the air outlet 40 toward the face of the occupant 2 when the seat back 12 is in the upright state. When the guide fin 50 is in the single chain line position shown by the single chain line in FIG. 5, air is blown out from the air outlet 40 toward the abdomen of the occupant 2, when the seat back 12 is in the upright position.

Further, as shown in FIG. 6, the guide fin 50 can be positioned to face upward such that the upstream end 52 of one of the plate-shaped members 51 is in contact with the inner wall 43 of the flow path forming the air outlet 40. The one of the plate-shaped members 51 is located at the lowermost side among the plate-shaped members 51. When the position of the guide fin 50 is upward as FIG. 6, the conditioned air is blown toward the upper side of the cabin as compared with the position of the guide fin 50 at the broken line position in FIG. 5.

In the present embodiment, a part of the plate-shaped members 51 abuts on the inner wall 43 of the flow path, so that the upward position can be achieved. However, the upward position may be realized by other methods. For example, the upward position may be realized by a part of the plate-shaped member 51 coming into contact with a structure (not shown) provided in the flow path. Further, the upward position may be realized by a portion of the one of the plate-shaped members 51 other than the end 53 abutting on the inner wall 43 of the flow path or the structure.

Further, the guide fin 50 may be capable of changing the flow direction of the conditioned air blown from the air outlet 40 in the left-right direction.

The controller 70 is arranged inside the instrument panel 3. The controller 70 has a microcomputer including a processor and a memory and peripheral circuits thereof. The memory of the controller 70 is composed of a non-transitional tangible storage medium.

The tilt sensor 20 and the front-rear position sensor 21 are connected to the input side of the controller 70. Further, various sensors used for controlling the air conditioner 30 such as an internal air temperature sensor 71 are connected to the input side of the controller 70. The internal air temperature sensor 71 detects the temperature of air in the cabin. Environmental information in the cabin necessary for controlling the air conditioner 30 such as the temperature in the cabin is input to the controller 70. Further, an operation unit (not shown) of the air conditioner is connected to the input side of the controller 70. The temperature, volume, etc. of the conditioned air are set by the occupant operating the operation unit. Setting information such as the temperature and volume of the conditioned air set by the occupant is input to the controller 70.

Further, the fin drive unit 60, the blower and the air mix door of the air conditioner 30, and the like are connected to the output side of the controller 70. The controller 70 performs various calculations and processes based on the control program stored in the memory. The controller 70 controls the operation of the fin drive unit 60 and the blower and the like of the air conditioner 30 based on the detection results of the various sensors such as the tilt sensor 20 and the setting information by the operation unit. As a result, the controller 70 controls the flow direction, temperature, and volume of the conditioned air blown out from the air outlet 40. In the present embodiment, the controller 70 is integrally configured with a control device that controls the air conditioner 30. However, the controller 70 may be configured separately from the control device that controls the air conditioner 30.

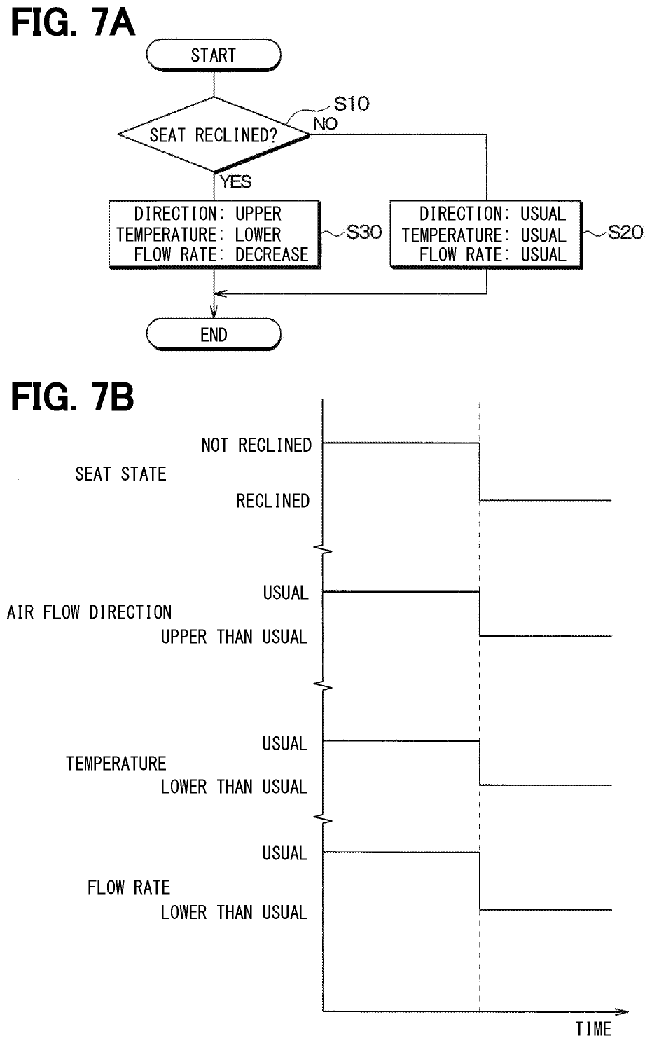

The control process executed by the controller 70 of the present embodiment will be described with reference to the flowchart of FIG. 7A. The control process is started when the ignition key of the vehicle 1 is turned on. Alternatively, if the vehicle 1 is an autonomous vehicle, it is started when the travel switch is turned on. The steps shown in FIG. 7A correspond to functional units that realize various functions.

In step S10, the controller 70 determines whether the seat back 12 is in the reclined state based on the information transmitted from the tilt sensor 20. Specifically, the controller 70 compares the information regarding the angle of the seat back 12 transmitted from the tilt sensor 20 with a threshold value stored in advance in the controller 70, to determine whether the seat back 12 is in the reclined state. When the controller 70 determines that the seat back 12 is not in the reclined state (that is, when it determines NO), the controller 70 proceeds to step S20.

In step S20, the controller 70 controls the fin drive unit 60 so that the guide fin 50 is positioned arbitrarily set by the occupant. If the occupant does not change the position of the guide fin 50, the controller 70 does not change the position of the guide fin 50. In the present embodiment, the position of the guide fin 50 is set to correspond to a predetermined portion of the occupant 2.

When the position of the guide fin 50 is set in the upward position in FIG. 6, the controller 70 controls the position within a range between the broken line position and the single chain line position in FIG. 5. For example, the position of the guide fin 50 in the upright state is stored in the memory immediately before the seat back 12 is switched from the upright state to the reclined state. The controller 70 changes the position of the guide fin 50 to the position in this upright state.

As a result, as shown in FIG. 1, when the seat back 12 is in the upright state, the conditioned air blown out from the air outlet 40 hits a predetermined portion of the occupant 2. In FIG. 1, the predetermined portion of the occupant 2 is the chest. The position of the guide fin 50 in FIG. 1 is the solid line position in FIG. 5. The position of the guide fin 50 can be arbitrarily changed by the operation of the occupant 2.

Further, in step S20, the controller 70 determines a target temperature and a target volume of the conditioned air blown out from the air outlet 40 based on the set temperature, the temperature of air in the cabin, and the like. The controller 70 controls the operation of the air conditioner 30 so that the temperature and the volume of the air blown from the air outlet 40 become the target temperature and the target volume respectively. Specifically, the controller 70 controls the door position of the air mix door and the air volume of the blower. The temperature and volume of the conditioned air blown out from the air outlet 40 can be arbitrarily changed by the operation of the occupant 2.

As described above, when the seat back 12 is in the upright state, the flow direction, temperature, and volume of the conditioned air blown out from the air outlet 40 are arbitrary. As a result, the conditioned air having an arbitrary temperature and an arbitrary volume is sent from the air outlet 40 to a predetermined portion of the occupant 2. Hereinafter, the flow direction, temperature, and volume of the conditioned air set when the seat back 12 is in the upright state are referred to as a usual direction, a usual temperature, and a usual volume respectively.

The controller 70 determines the blowing mode based on the set temperature, the cabin interior temperature, and the like. Examples of the blowing mode include a face mode in which the conditioned air is blown from the face outlet, a defroster mode in which the conditioned air is blown from the defroster air outlet, and a foot mode in which the conditioned air is blown from the foot air outlet. In the present embodiment, the set temperature is lower than the temperature of air inside the cabin. Therefore, the blowing mode determined by the controller 70 is the face mode. Further, the occupant 2 may select the face mode as the blowing mode.

In step S10, when the controller 70 determines that the seat back 12 is in the reclined state (that is, when it is determined YES), the controller 70 proceeds to step S30.

In step S30, the controller 70 controls the fin drive unit 60 so that the position of the guide fin 50 is set to the upward position shown in FIG. 6.

As a result, when the seat back 12 is switched from the upright state to the reclined state, the flow direction of the conditioned air blown out from the air outlet 40 is set to be upward than usual, as shown in FIG. 7B. That is, as shown in FIG. 2, the conditioned air is blown out from the air outlet 40. The flow direction of the conditioned air at this time is toward the upper side of the cabin as compared with the case of the upright state immediately before the seat back 12 is switched to the reclined state.

In this way, the controller 70 controls the fin drive unit 60 to change the flow direction of the conditioned air blown from the air outlet 40 toward the upper side of the cabin based on the state of the seat back 12 being switched from the upright state to the reclined state. When the temperature of the conditioned air is lower than the temperature of the air inside the cabin, the conditioned air has a higher density than the air inside the cabin. Therefore, the conditioned air blown toward the upper side of the cabin falls toward the occupant due to gravity. The flow direction of the conditioned air toward the occupant while falling is closer to the vertical direction than before the flow direction of the conditioned air blown from the air outlet 40 is changed.

Further, in step S30, the controller 70 lowers the target temperature of the conditioned air blown out from the air outlet 40. The controller 70 controls the air conditioner 30 so that the temperature of the air blown from the air outlet 40 has the lowered target temperature.

As a result, as shown in FIG. 7B, when the seat back 12 is switched from the upright state to the reclined state, the temperature of the conditioned air blown out from the air outlet 40 becomes lower than usual. More specifically, the temperature of the conditioned air blown out from the air outlet 40 is lower than that in the upright state immediately before the seat back 12 is switched to the reclined state.

In this way, the controller 70 lowers the temperature of the conditioned air blown out from the air outlet 40 based on the state of the seat back 12 being switched from the upright state to the reclined state. As the temperature of the conditioned air is lowered, the density of the conditioned air increases as compared with before the temperature of the conditioned air is lowered. For this reason, the density difference between the conditioned air and the air inside the cabin becomes larger, so that the flow direction of the conditioned air toward the occupant while falling becomes closer to the vertical direction.

Further, in step S30, the controller 70 controls the air conditioner 30 so as to reduce the volume of the air blown from the air outlet 40. The control of the air conditioner 30 is specifically to reduce the air volume of the blower.

As a result, as shown in FIG. 7B, when the seat back 12 is switched from the upright state to the reclined state, the volume of the conditioned air blown out from the air outlet 40 becomes smaller than usual. Specifically, the amount of conditioned air blown out from the air outlet 40 is reduced as compared with the case where the seat back 12 is in the upright state immediately before switching to the reclined state. In this way, the controller 70 reduces the amount of conditioned air blown out from the air outlet 40 based on the state of the seat back 12 being switched from the upright state to the reclined state.

When the flow direction of the conditioned air blown from the air outlet 40 changes, as shown in FIG. 6, toward the upper side of the cabin, the conditioned air from the air outlet 40 reaches to a position farther from the air outlet 40 compared with the timing before the flow direction is changed to the upper side. Therefore, the controller 70 reduces the volume of the conditioned air blown out from the air outlet 40. The amount of decrease in volume at this time is set in advance in the memory of the controller 70 by experiments or the like so that the conditioned air hits the same predetermined portion of the occupant as in the upright state even when the seat back 12 is switched to the reclined state. In other words, the controller 70 reduces the volume of the conditioned air blown out from the air outlet so that the conditioned air hits the same predetermined portion of the occupant in the upright state.

As a result, even if the seat back 12 is in the reclined state, the conditioned air can be sent to the same predetermined portion of the occupant as when the seat back 12 is in the upright state.

Further, the controller 70 determines whether the position of the seat cushion 11 has been changed in the front-rear direction based on the information transmitted from the front-rear position sensor 21. When the position of the seat cushion 11 in the front-rear direction is changed, the controller 70 adjusts the volume of the conditioned air blown out from the air outlet according to the position of the seat cushion 11. The adjustment amount in the air volume at this time is set in advance by experiments or the like and is stored in the memory of the controller 70, so that the conditioned air hits the same predetermined portion of the occupant as in the upright state. As a result, even if the seat back 12 is tilted backward and the position of the seat cushion 11 in the front-rear direction is changed, the conditioned air can be sent to the same predetermined portion of the occupant as when the seat back 12 is in the upright state.

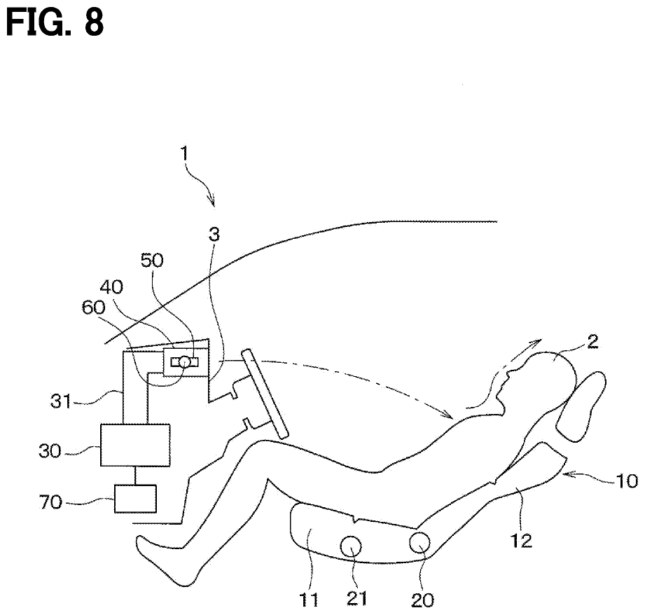

For comparison with the present embodiment, FIG. 8 shows a flow of conditioned air blown out from the air outlet 40 in case of Comparative Example 2. Comparative Example 2 corresponds to a case where the above-mentioned combination device blows out wind from the face outlet toward the chest of the occupant when the seat back is in the reclined state. In Comparative Example 2, the position of the guide fin 50, when the seat back 12 is in the backward tilted state, is set to blow out the wind in the linear state from the air outlet 40 toward the chest of the occupant 2. The linear state means a state in which the wind flows straightly.

In Comparative Example 2, as in the present embodiment, the air outlet is at a lower position than a conventional device. Further, in Comparative Example 2, when the seat back 12 is in the reclined state, the flow direction of the conditioned air blown out from the air outlet 40 is toward the lower side than that when the seat back 12 is in the upright state. Therefore, when the seat back 12 is in the reclined state, as shown in FIG. 8, the conditioned air blown out from the air outlet 40 reaches the chest of the occupant 2 and then flow along the body of the occupant 2 from the lower side to the upper side. In this case, as described above, the occupant 2 may feel uncomfortable.

In contrast, according to the present embodiment, the conditioned air blown from the air outlet 40 toward the occupant 2 flows from the air outlet 40 toward the upper side of the cabin. The conditioned air will be like falling down to the occupant 2 from the upper side. As a result, it is possible to restrict the occupant 2 from feeling uncomfortable.

In the present embodiment, the chest of the occupant 2 receives the conditioned air. However, the conditioned air may be applied to a predetermined portion other than the chest of the occupant 2. The predetermined portion other than the chest includes a neck, abdomen, thigh and the like.

Further, in the present embodiment, the controller 70 controls the guide fin 50 and the air conditioner 30 so that the conditioned air reaches the same portion of the occupant as in the upright state when the seat back 12 is switched from the upright state to the reclined state. However, the controller 70 may control the guide fin 50 and the air conditioner 30 so as to blow the conditioned air to a part of the occupant different from that in the upright state. In this case, the amount of reduction in the volume of the conditioned air by the controller 70 may be set so that the conditioned air hits the occupant 2 when the seat back 12 is switched to the reclined state. As a result, even if the seat back 12 is tilted backward, the conditioned air can reach the predetermined portion of the occupant 2.

### Second Embodiment

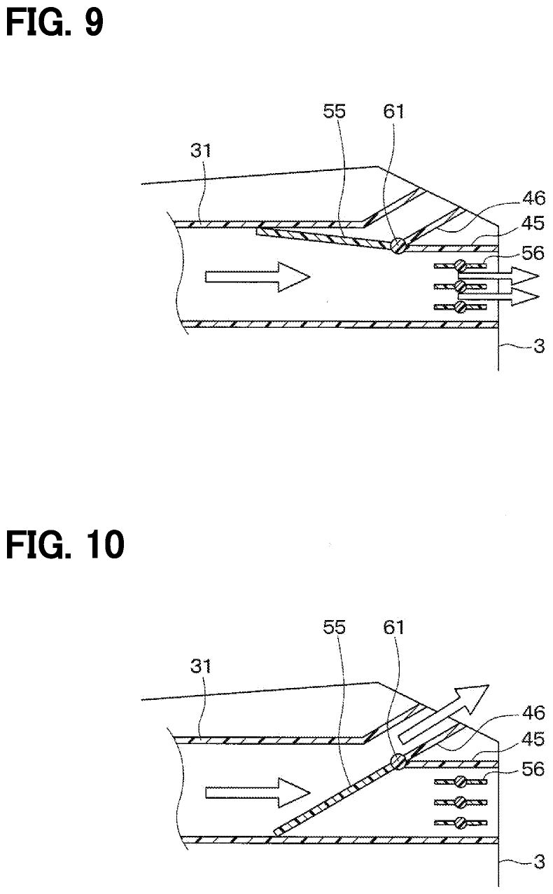

As shown in FIGS. 9 and 10, in the present embodiment, the air-conditioning control system includes a face outlet 45, a dedicated outlet 46, a switching door 55, and a door drive unit 61.

The face outlet 45 corresponds to the air outlet 40 of the first embodiment. A guide fin 56 is arranged in the internal space of the face outlet 45. Similar to the guide fin 50 of the first embodiment, the guide fin 56 changes the flow direction of the conditioned air blown from the air outlet 40 in the vertical direction. However, the range within which the guide fin 56 changes the flow direction of the conditioned air does not include the flow direction of the conditioned air shown in FIG. 6.

The dedicated outlet 46 is provided at a position above the face outlet 45 in the instrument panel 3. The dedicated outlet 46 is connected to the duct 31 that connects the air conditioner 30 and the face outlet 45. The dedicated outlet 46 blows the conditioned air toward the upper side of the cabin with respect to the face outlet 45.

The switching door 55 is arranged on the upstream side of the face outlet 45 and the dedicated outlet 46 inside the duct 31. The switching door 55 switches a flow of air conditioned by the air conditioner 30 to flow toward the face outlet 45 or toward the dedicated outlet 46.

The door drive unit 61 drives the switching door 55. The operation of the door drive unit 61 is controlled by the controller 70.

In the present embodiment, the face outlet 45 and the dedicated outlet 46 are provided on the instrument panel 3 and correspond to an outlet that blows out the air conditioned by the air conditioner into the cabin. The switching door 55 corresponds to a wind direction variable mechanism capable of changing the flow direction of the conditioned air blown from the air outlet in the vertical direction. The door drive unit 61 corresponds to a drive unit that drives the wind direction variable mechanism.

In the present embodiment, the control process executed by the controller 70 of the first embodiment is changed as follows.

In step S20, as shown in FIG. 9, the controller 70 sets the position of the switching door 55 such that the air conditioned by the air conditioner 30 flows to the face outlet 45. As a result, when the seat back 12 is in the upright state, the conditioned air is blown from the face outlet 45 toward the upper body of the occupant 2.

In step S30, as shown in FIG. 10, the controller 70 controls the door drive unit 61 to set the position of the switching door 55 such that the air conditioned by the air conditioner 30 flows to the dedicated outlet 46. When the seat back 12 is switched from the upright state to the reclined state, the conditioned air is blown from the dedicated outlet 46 toward the upper side of the cabin. In this way, the controller 70 controls the fin drive unit 60 so that the flow direction of the conditioned air blown from the air outlet changes toward the upper side of the cabin.

The parts other than the above-described control process are the same as those in the first embodiment. Therefore, the same effect as that of the first embodiment can be obtained in this embodiment. Further, according to the present embodiment, the following effects can be obtained.

In the present embodiment, when the seat back 12 is in the reclined state, the conditioned air is blown out from the dedicated outlet 46, so that the pressure loss of the conditioned air due to the guide fin 56 of the face outlet 45 is eliminated. Therefore, the conditioned air blown out from the dedicated outlet 46 can be efficiently delivered to the occupant 2.

### Third Embodiment

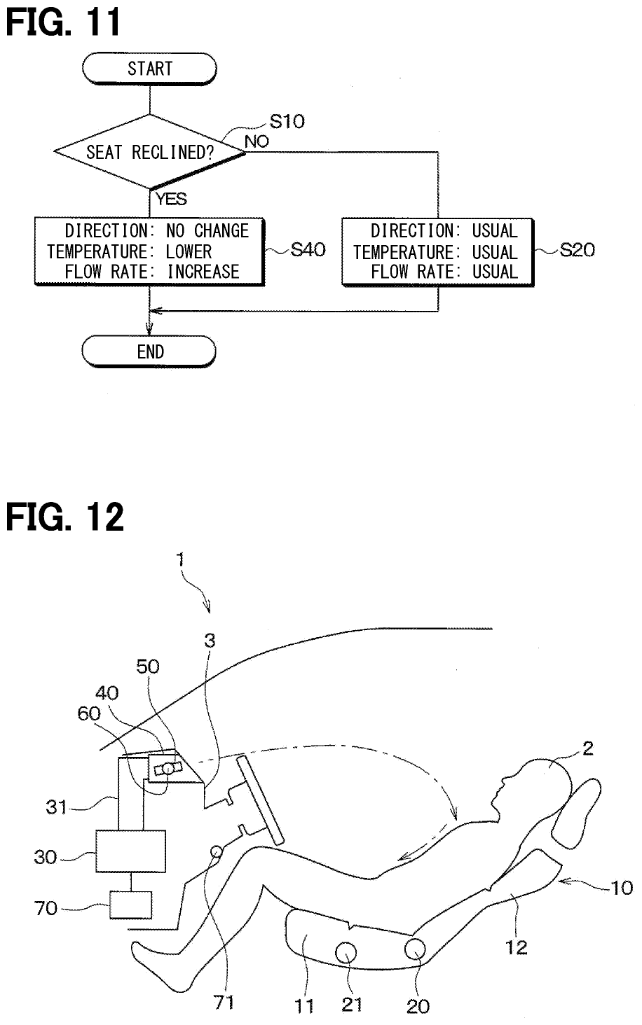

The control process executed by the controller 70 of the present embodiment will be described. As shown in FIG. 11, step S30 of FIG. 7A in the control process executed by the controller 70 of the first embodiment is changed to step S40 in the present embodiment.

In step S40, the controller 70 does not change the flow direction of the conditioned air blown from the air outlet 40 with respect to the usual direction. The controller 70 lowers the target temperature of the conditioned air blown out from the air outlet 40. The controller 70 controls the air conditioner 30 so that conditioned air blown from the air outlet 40 has the lowered target temperature.

As a result, when the seat back 12 is switched from the upright state to the reclined state, the temperature of the conditioned air blown out from the air outlet 40 becomes lower than usual. More specifically, the temperature of the conditioned air blown out from the air outlet 40 is lower than that in the upright state immediately before the seat back 12 is switched to the reclined state. In this way, the controller 70 lowers the temperature of the conditioned air blown out from the air outlet 40 based on the state of the seat back 12 being switched from the upright state to the reclined state.

The temperature of air conditioned by the air conditioner 30 is lower than the temperature of the air inside the cabin. Therefore, the conditioned air has a higher density than the air inside the cabin. Further, in step S40, the temperature of the conditioned air blown out from the air outlet 40 is lowered. As a result, the density of the conditioned air becomes higher. Therefore, as shown in FIG. 12, the conditioned air blown out from the air outlet 40 flows toward the occupant while falling due to gravity. The flow direction of the conditioned air toward the occupant while falling is closer to the vertical direction than that before the temperature of the conditioned air is lowered. Therefore, the same effect as that of the first embodiment can be obtained by this embodiment as well.

Further, in step S40, the controller 70 controls the air conditioner 30 so as to increase the volume of the conditioned air blown from the air outlet 40. The control of the air conditioner 30 is specifically to increase the air volume of the blower. As a result, when the seat back 12 is switched from the upright state to the reclined state, the volume of conditioned air blown out from the air outlet 40 is increased, compared with the case where the seat back 12 is in the upright state immediately before the seat back 12 is switched to the reclined state. In this way, the controller 70 increases the volume of the conditioned air blown out from the air outlet 40 based on the state of the seat back 12 being switched from the upright state to the reclined state.

When the temperature of the conditioned air blown out from the air outlet 40 lowers, the distance reached by the conditioned air from the air outlet 40 becomes shorter than that before the temperature of the conditioned air decreases. Therefore, when the temperature of the conditioned air blown out from the air outlet 40 is lowered, the controller 70 increases the volume of the conditioned air blown out from the air outlet 40. The amount of increase in the volume at this time is set in advance by experiments or the like and is stored in the memory of the controller 70, so that the conditioned air hits the same predetermined portion of the occupant as in the upright state even when the seat back 12 is switched to the reclined state. In other words, the controller 70 increases the volume of the conditioned air blown out from the air outlet so that the conditioned air hits the same portion of the occupant 2 as when the seat back 12 is in the upright state.

As a result, as shown in FIG. 12, even if the seat back 12 is in the reclined state, the conditioned air can reach the same portion as when the seat back 12 is in the upright state.

When the seat back 12 is switched from the upright state to the reclined state, the controller 70 may increase the volume of the conditioned air so as to send the conditioned air to a part of the occupant different from that in the upright state. The amount of increase in the volume in this case is set so that the occupant 2 is exposed to the conditioned air when the seat back 12 is switched to the reclined state. As a result, even if the seat back 12 is reclined, the conditioned air can reach the predetermined portion of the occupant 2.

### OTHER EMBODIMENTS

(1) In step S30 of the control process of the first embodiment, the controller 70 controls the fin drive unit 60 so that the position of the guide fin 50 is set to the upward position shown in FIG. 6. However, the position of the guide fin 50 at this time does not have to be the upward position shown in FIG. 6 while the flow direction of the conditioned air blown from the air outlet 40 changes to the upper side of the cabin.

For example, when the position of the guide fin 50 in the upright state is the solid line position in FIG. 5, the controller 70 may change the position of the guide fin 50 to the broken line position in FIG. 5. Further, when the position of the guide fin 50 in the upright state is the single chain line position in FIG. 5, the controller 70 may change the position of the guide fin 50 to the solid line position in FIG. 5. In this way, the controller 70 controls the fin drive unit 60 to change the flow direction of the conditioned air blown from the air outlet 40 toward the upper side of the cabin based on the state of the seat back 12 being switched from the upright state to the reclined state.

In this case, when the seat back 12 is in the backward tilted state, the conditioned air blown from the air outlet 40 is directed toward the upper side of the cabin as compared with the case where the seat back 12 is in the upright state immediately before switching to the backward tilted state. Since the temperature of the conditioned air is lower than the temperature of the air inside the cabin, the conditioned air blown toward the upper side of the cabin falls toward the occupant due to gravity. The flow direction of the conditioned air toward the occupant while falling is closer to the vertical direction than that before the flow direction of the conditioned air blown from the air outlet 40 is changed. Therefore, the same effect as that of the first embodiment can be obtained.

(2) In each of the embodiments, the tilt sensor 20 is used as the seat back state detector. However, the seat back state detector may be a rotation angle sensor that detects the rotation angle of the motor that moves the seat back 12, an in-vehicle camera that images the seat 10 or the occupant 2 on the seat 10, and the like.

When the rotation angle sensor is used, the controller 70 compares the information transmitted from the rotation angle sensor with a threshold value stored in advance in the controller 70 in step S10 of the control process of the first embodiment so as to determine whether the seat back 12 is in the reclined state.

When the in-vehicle camera is used, the controller 70 analyzes the image captured by the in-vehicle camera in step S10 of the control process of the first embodiment to determine whether the seat back 12 is in the reclined state.

Further, when a sleep switch for putting the seat back 12 in the reclining state is provided, the sleep switch may be used as the seat back state detector. In this case, it is transmitted to the controller 70. The controller 70 determines whether the seat back 12 is in the reclined state based on the information transmitted from the sleep switch whether or not the sleep switch is turned on.

(3) In each of the embodiments, in steps S30 and S40, in order to lower the temperature of the conditioned air blown from the air outlet 40, the controller 70 lowers the target temperature of the conditioned air blown from the air outlet 40. However, the controller 70 may operate a cooling device provided in the duct 31 instead of lowering the target temperature of the conditioned air.

(4) In the first embodiment, in step S30, the controller 70 reduces the air volume of the blower in order to reduce the volume of the conditioned air blown from the air outlet 40. However, instead of reducing the air volume of the blower, the controller 70 may move an air outlet mode door for switching the air outlet mode of the air conditioner 30 to reduce the air distribution ratio to the air outlet 40. Further, when the air outlet 40 is provided with an opening adjusting mechanism for adjusting the width of the opening of the air outlet 40, the controller 70 may narrow the opening of the air outlet 40 by the opening adjusting mechanism.

(5) In the third embodiment, in step S40, the controller 70 increases the air volume of the blower in order to increase the volume of the conditioned air blown from the air outlet 40. However, instead of increasing the air volume of the blower, the controller 70 may move the air outlet mode door for switching the air outlet mode of the air conditioner 30 to increase the air distribution ratio to the air outlet 40. Further, when the air outlet 40 is provided with an opening adjusting mechanism for adjusting the width of the opening of the air outlet 40, the controller 70 may widen the opening of the air outlet 40 by the opening adjusting mechanism.

(6) In each of the embodiments, the present disclosure is applied to a general face outlet. However, the present disclosure can be applied to an air outlet different from a general face outlet while the air outlet is provided on the instrument panel to blow the conditioned air toward the occupant.

(7) The present disclosure is not limited to the foregoing description of the embodiments and can be modified within the scope of the present disclosure. The present disclosure may also be varied in many ways. Such variations are not to be regarded as departure from the disclosure, and all such modifications are intended to be included within the scope of the disclosure. The above embodiments are not independent of each other, and can be appropriately combined together except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### Overview

According to the first aspect shown in part or all of the embodiments, the air conditioning control system for a vehicle includes: a seat disposed in a cabin; an air conditioner configured to send a conditioned air that is lower in temperature than air inside the cabin; an air outlet provided in an instrument panel to blow the conditioned air into the cabin; a wind direction variable mechanism configured to change a flow direction of the conditioned air blown out from the air outlet in a vertical direction; a drive unit that drives the wind direction variable mechanism; a detector configured to detect a state of a seat back of the seat; and a controller that controls the drive unit based on a detection result of the detector. The controller controls the drive unit such that the flow direction of the conditioned air blown out from the air outlet changes to upward in the cabin based on the state of the seat back being switched from an upright state to a reclined state.

Further, according to the second aspect, the controller lowers the temperature of the conditioned air blown out from the air outlet based on the state of the seat back being switched from the upright state to the reclined state in the first aspect.

Accordingly, when the seat back is switched from the upright state to the reclined state, the temperature of the conditioned air blown out from the air outlet is lowered. As the temperature of the conditioned air lowers, the density of the conditioned air increases as compared with that before the temperature of the conditioned air lowers. For this reason, the density difference between the conditioned air and the air inside the cabin becomes larger, so that the flow direction of the conditioned air toward the occupant while falling becomes closer to the vertical direction.

As a result, when the seat back is in the reclined state, the air blown from the air outlet can be further suppressed from flowing along the body of the occupant after reaching a predetermined part of the occupant.

Further, according to the third aspect, the controller reduces the volume of conditioned air blown out from the air outlet based on the state of the seat back being switched from the upright state to the reclined state in the first and second aspects.

When the flow direction of the conditioned air blown out from the air outlet changes to the upper side of the cabin, the conditioned air from the air outlet reaches a position farther from the air outlet compared with a time before the flow direction is changed to the upper side. Therefore, when the seat back is switched from the upright state to the reclined state and the flow direction of the conditioned air blown from the air outlet changes to the upper side of the cabin, the controller reduces the volume of the conditioned air blown out from the air outlet. As a result, even if the seat back is tilted backward, the conditioned air can reach a predetermined portion of the occupant.

At this time, it is preferable that the controller reduces the volume of the conditioned air blown out from the air outlet so that the conditioned air hits the same predetermined portion of the occupant in the upright state. As a result, even if the seat back is tilted backward, the conditioned air can be sent to the same predetermined portion of the occupant as when the seat back is in the upright state.

Further, according to the fourth aspect, the air-conditioning control system includes: a seat disposed in a cabin; an air conditioner configured to send a conditioned air that is lower in temperature than air inside the cabin; an air outlet provided in an instrument panel to blow the conditioned air into the cabin; a detector configured to detect a state of a seat back of the seat; and a controller that controls temperature of the conditioned air blown out from the air outlet based on a detection result of the detector. The controller lowers the temperature of the conditioned air blown out from the air outlet based on the state of the seat back being switched from the upright state to the reclined state.

Further, according to the fifth aspect, the controller increases the amount of conditioned air blown out from the air outlet based on the state of the seat back being switched from the upright state to the reclined state in the fourth aspect.

When the temperature of the conditioned air blown out from the air outlet lowers, the distance by which the conditioned air reaches from the air outlet becomes shorter than that before the temperature of the conditioned air lowers. Therefore, the controller increases the volume of the conditioned air blown from the air outlet in response to lowering the temperature of the conditioned air blown from the air outlet. As a result, even if the seat back is tilted backward, the conditioned air can reach a predetermined portion of the occupant.

At this time, it is preferable that the controller increases the volume of the conditioned air blown out from the air outlet so that the conditioned air hits the same portion of the occupant as when the seat back is in the upright state. As a result, even if the seat back is in the reclined state, the conditioned air can reach the same portion as when the seat back is in the upright state.

Further, according to the sixth aspect, the control device is used for air conditioning of the vehicle equipped with a seat placed in the cabin, an air conditioner that generates conditioned air that is cooler than air in the cabin, an air outlet defined in the instrument panel to blow the conditioned air into the cabin, a wind direction variable mechanism that can change the flow direction of the conditioned air blown out in the vertical direction, a drive unit that drives the wind direction variable mechanism, and a detector that detects the state of the seat back of the seat. The control device controls the drive unit so that the flow direction of the conditioned air blown from the air outlet changes to the upper side of the cabin based on the seat back state being switched from the upright state to the reclined state.

Further, according to the seventh aspect, the control device is used for air conditioning of the vehicle equipped with a seat arranged in the cabin, an air conditioner that generates conditioned air having a temperature lower than that of air in the cabin, an air outlet provided on the instrument panel to blow the conditioned air into the cabin, and a detector that detects the state of the seat back of the seat. The control device lowers the temperature of the conditioned air blown out from the air outlet based on the seat back being switched from the upright state to the reclined state.

What is claimed is:

1. An air conditioning control system for a vehicle comprising:
a seat disposed in a cabin;
an air conditioner configured to send a conditioned air that is lower in temperature than air inside the cabin;
an air outlet provided in an instrument panel to blow the conditioned air into the cabin;
a detector configured to detect a state of a seat back of the seat; and
a controller that controls temperature of the conditioned air blown out from the air outlet based on a detection result of the detector, wherein
the controller lowers the temperature of the conditioned air blown out from the air outlet based on the state of the seat back being switched from an upright state to a reclined state, and
the controller increases a volume of the conditioned air blown out from the air outlet in response to lowering the temperature of the conditioned air blown out from the air outlet.

2. A control device for air-conditioning of a vehicle including a detector configured to detect a state of a seat back of a seat disposed in a cabin of the vehicle, the control device comprising:
a controller configured to control a conditioned air conditioned by an air conditioner and blown out from an air outlet provided in an instrument panel to blow the conditioned air into the cabin, wherein
the controller lowers temperature of the conditioned air blown out from the air outlet when the detector detects that a state of the seat back being switched from an upright state to a reclined state, and
the controller increases a volume of the conditioned air blown out from the air outlet in response to lowering the temperature of the conditioned air blown out from the air outlet.
